(19) United States
(12) Patent Application Publication
(10) Pub. No.: US 2016/0259539 A1
(43) Pub. Date: Sep. 8, 2016

(54) USER TERMINAL DEVICE, DIGITAL SIGNAGE DEVICE, AND CONTROLLING METHODS THEREOF

(71) Applicant: SAMSUNG ELECTRONICS CO., LTD., Suwon-si (KR)

(72) Inventors: Hae-in LEE, Seongnam-si (KR); Dong-hyun KIM, Seoul (KR); Kyoung-nyo HWANGBO, Suwon-si (KR); Ha-jeong YUN, Seoul (KR)

(73) Assignee: SAMSUNG ELECTRONICS CO., LTD., Suwon-si (KR)

(21) Appl. No.: 15/061,347

(22) Filed: Mar. 4, 2016

Related U.S. Application Data
(60) Provisional application No. 62/128,105, filed on Mar. 4, 2015.

(30) Foreign Application Priority Data
Aug. 27, 2015 (KR) 10-2015-0120831

(51) Int. Cl. G06F 3/0484; G06F 17/21; G06Q 30/02; G06F 3/0481; G06F 3/0482; G09F 27/00; H04W 4/02; G06F 17/24

(52) U.S. Cl. CPC G06F 3/04847; H04W 4/023; G06F 17/212; G06F 17/248; G06F 3/0481; G06F 3/0482; G06F 3/04842; G09F 27/005; G06Q 30/0269

(57) ABSTRACT

A user terminal device includes a display, a communicator configured to perform communication with a digital signage device and a processor configured to control the display to display user interface (UI) screens for managing a content to be displayed on the digital signage device and schedules sequentially, configured to combine information input from each of the UI screens displayed sequentially and configured to transmit the combined information to the digital signage device.

### CROSS-REFERENCE TO RELATED APPLICATIONS

This application claims priority from Korean Patent Application No. 10-2015-0120831, filed in the Korean Intellectual Property Office on Aug. 27, 2015, and U.S. Provisional Patent Application No. 62/128,105, filed in the United States Patent and Trademark Office on Mar. 4, 2015, the disclosures of which are incorporated herein by references in their entireties.

### BACKGROUND

1. Field of the Invention

Methods and apparatuses consistent with exemplary embodiments relate to a user terminal device, a digital signage device, and controlling methods thereof, and more particularly, to a user terminal device for editing a displayed content and managing a schedule, a digital signage device and controlling methods thereof.

2. Description of the Related Art

With the development of electronic technologies, various types of electronic products have been developed and distributed, and electronic apparatus with various information-providing functions have been used. Further, the electronic products which have been used indoors conventionally are now in use on streets, shops, etc.

Digital signage refers to outdoor advertising using digital information display (DID), which is installed not only on streets and shops but also on an outer wall of a building to perform the function of advertisement.

In the related art, in consideration of a business-to-business (B2B) market where contents are managed by the unit of shop, contents have been produced and managed by professionals using a server as a medium and thus, a digital signage device has complicated functions.

Specifically, in order to generate a new schedule when editing schedules of the advertisements, a digital signage device of the related art requires a new registration of schedule each and every time. In particular, in case of a small-scale market, there is no available method for a shop owner to produce contents and reproduce schedules by himself or herself.

Further, in the related art, same contents have been reproduced all the time regardless of customers, and contents have not been optimized for gender or age of customers, which compromises the advertising effect of the contents.

### SUMMARY

One or more exemplary embodiments provide a user terminal device which provides a UI screen for editing contents and managing schedules and displays contents in accordance with users' needs, a digital signage device and controlling methods thereof.

According to an aspect of an exemplary embodiment, there is provided a user terminal device including a display, a communicator configured to perform communication with a digital signage device, and a processor configured to display UI screens for editing a content to be provided on the digital signage device and managing schedules sequentially, and control to transmit information which is generated by combining information input from each of the UI screens displayed sequentially to the digital signal device.

The processor may display a first UI screen for receiving shop information related to a content to be provided on the digital signage device, a second UI screen for editing the content, and a third UI screen for managing display schedules of the content sequentially.

The processor, in response to shop information being input on the first UI screen, may provide candidate contents related to the input shop information on the second UI screen, and in response to at least one content being selected from among the candidate contents provided on the second UI screen, may display on the third UI screen a basic display schedule management screen which is generated by applying a predetermined schedule template corresponding to the input shop information to the selected content.

The processor, in response to customer information acquired from the digital signage device being received, may provide on the second UI screen the received customer information and candidate contents related to the input shop information.

The UI screen may include a first area for receiving a user command and a second area for providing preview of a screen which is provided on the digital signage device, and the processor may display on the second area a preview screen where information input on the first area is applied to a predetermined layout, change the layout automatically according to a user command and display a preview screen where the input information is applied to a changed layout.

The processor, in response to a digital signage device being detected within a predetermined scope from the user terminal device, may provide information regarding the detected digital signage device, and in response to a predetermined user command regarding the digital signage device being input, display a UI screen for editing display schedule information received from the digital signage device.

The processor may provide the content to correspond to display attributes of the digital signage device based on display attributes information corresponding to model information of the digital signage device.

According to an aspect of another exemplary embodiment, there is provided a digital signage device including a storage, a communicator configured to perform communication with a user terminal device, a display configured to display a content, and a processor configured to, in response to display information which is generated by combining information input through a UI screen of the user terminal device and a content which is provided according to the display information being received from the user terminal device, store the received information in the storage and display a content corresponding to the display information through the display in real time based on the stored information.

The device may further include a camera, and the processor may acquire customer information including at least one of gender, race and age from an image which is photographed by the camera in real time, and display a content corresponding to the acquired customer information.

The content may include tag information according to characteristics of each content, and the processor may display a content including tag information corresponding to the acquired customer information.

According to an aspect of another exemplary embodiment, there is provided a method of controlling a user terminal device including displaying UI screens for editing a content to be provided on a digital signage device and managing display schedules sequentially and transmitting information which is generated by combining information which is input from each of the UI screens displayed sequentially to the digital signage device.

The displaying may include displaying a first UI screen for receiving shop information related to a content to be provided on the digital signage device, a second UI screen for editing the content, and a third UI screen for managing display schedules of the content sequentially.

The displaying may include, in response to shop information being input on the first UI screen, providing candidate contents related to the input shop information on the second UI screen, and in response to at least one content being selected from among the candidate contents provided on the second UI screen, displaying on the third UI screen a basic display schedule management screen which is generated by applying a predetermined schedule template corresponding to the input shop information to the selected content.

The displaying may include, in response to customer information acquired from the digital signage device being received, providing on the second UI screen the received customer information and candidate contents related to the input shop information.

The UI screen may include a first area for receiving a user command and a second area for providing preview of a screen which is provided on the digital signage device, and the displaying may include, displaying on the second area a preview screen where information input on the first area is applied to a predetermined layout, changing the layout automatically according to a user command and displaying a preview screen where the input information is applied to a changed layout.

The method may further include, in response to a digital signage device being detected within a predetermined scope from the user terminal device, providing information regarding the detected digital signage device, and in response to a predetermined user command regarding the digital signage device being input, displaying a UI screen for editing display schedule information received from the digital signage device.

The displaying may include providing the content to correspond to display attributes of the digital signage device based on display attributes information corresponding to model information of the digital signage device.

According to an aspect of another exemplary embodiment, there is provided a method of controlling a digital signage device including receiving display information which is generated by combining information input through a UI screen of the user terminal device and a content which is provided according to the display information from the user terminal device, storing the received information, and displaying a content corresponding to the display information through the display in real time based on the stored information.

The displaying may include acquiring customer information including at least one of gender, race and age from an image which is photographed by the camera in real time and displaying a content corresponding to the acquired customer information.

The content may include tag information according to characteristics of each content, and the displaying may include displaying a content including tag information corresponding to the acquired customer information.

According to an aspect of another exemplary embodiment, there is provided a user terminal device, including: a display; a communicator configured to perform communication with a digital signage device; and a processor configured to control the display to display user interface (UI) screens for managing a content to be displayed on the digital signage device and schedules sequentially, configured to combine information input from each of the UI screens displayed sequentially and configured to transmit the combined information to the digital signage device.

The processor is configured to control the display to sequentially display a first UI screen for receiving first information related to the content to be displayed on the digital signage device, to display a second UI screen for editing the content, and to display a third UI screen for managing display schedules of the content.

The processor, in response to the first information being input on the first UI screen, may be configured to control the display to provide candidate contents related to the input first information on the second UI screen, and in response to at least one content being selected from among the candidate contents provided on the second UI screen, the processor may be configured to control the display to display the third UI screen including a basic display schedule management screen which is generated by applying a predetermined schedule template corresponding to the input first information to the selected at least one content.

The processor, in response to receiving customer information from the digital signage device, may be configured to control the display to provide the received customer information and candidate contents related to the input first information on the second UI screen.

The processor may be configured to control the display to display the UI screen including a first area for receiving a user command and a second area for providing a preview of the content to be displayed on the digital signage device, and the processor may be configured to control the display to display a preview having information input from the first area being applied to a predetermined layout on the second area, configured to change the predetermined layout automatically based on the user command and configured to control the display to display a preview including the input information being applied to the changed layout.

The processor, in response to a digital signage device being detected within a predetermined distance from the user terminal device, may be configured to control the user terminal device to provide information regarding the detected digital signage device, and in response to a predetermined user command regarding the digital signage device being input, the processor may be configured to control the display to display a UI screen for editing display schedule information received from the digital signage device.

The processor may be configured to control the display to provide the content based on display attributes of the digital signage device including model information of the digital signage device.

According to an aspect of another exemplary embodiment, there is provided a digital signage device including: a storage; a communicator configured to perform communication with a user terminal device; a display configured to display a content; and a processor configured to, in response to display information which is generated by combining information input through a UI screen of the user terminal device and a content which is provided according to the display information being received from the user terminal device, store the received display information in the storage and display the content on the display in real time based on the stored display information.

The device may further include: a camera configured to generate an image, wherein the processor may be configured to acquire customer information including at least one of gender, race and age from the image photographed by the camera in real time, and configured to control the display to display a content corresponding to the acquired customer information.

The content may include tag information based on characteristics of the content, wherein the processor may be configured to control the display to display a content including tag information corresponding to the acquired customer information.

According to an aspect of another exemplary embodiment, there is provided a method of controlling a user terminal device including: displaying UI screens for managing a content to be displayed on a digital signage device and display schedules sequentially; combining information input from each of the UI screens displayed sequentially; and transmitting the combined information to the digital signage device.

The displaying the UI screens may include sequentially displaying a first UI screen for receiving first information related to the content to be displayed on the digital signage device, a second UI screen for editing the content, and a third UI screen for managing display schedules of the content.

The displaying the UI screens may include: in response to the first information being input on the first UI screen, providing candidate contents related to the input first information on the second UI screen, and in response to at least one content being selected from among the candidate contents provided on the second UI screen, displaying the third UI screen including a basic display schedule management screen generated by applying a predetermined schedule template corresponding to the input first information to the selected at least one content.

The displaying the UI screens may include, in response to receiving customer information from the digital signage device, providing the received customer information and candidate contents related to the input first information on the second UI screen.

The UI screen may include: a first area for receiving a user command; and a second area for providing preview of the content to be displayed on the digital signage device, wherein the displaying the UI screens includes, displaying a preview having information input from the first area being applied to a predetermined layout on the second area, changing the predetermined layout automatically based on the user command and displaying a preview including the input information being applied to the changed layout.

The method may further include: in response to a digital signage device being detected within a predetermined distance from the user terminal device, providing information regarding the detected digital signage device; and in response to a predetermined user command regarding the digital signage device being input, displaying a UI screen for editing display schedule information received from the digital signage device.

The displaying may include providing the content based on display attributes of the digital signage device including model information of the digital signage device.

According to an aspect of another exemplary embodiment, there is provided a method of controlling a digital signage device including: receiving display information generated by combining information input through a UI screen of the user terminal device; receiving a content which is provided according to the display information from the user terminal device; storing the received display information; and displaying the content on the display in real time based on the stored display information.

The method may further include: photographing an image in real time; acquiring customer information including at least one of gender, race and age from the image photographed in real time; and displaying a content corresponding to the acquired customer information.

The content may include tag information based on characteristics of the content, wherein the displaying may include displaying a content including tag information corresponding to the acquired customer information.

According to an aspect of another exemplary embodiment, there is provided a user terminal device including: a communicator configured to perform communication with a digital signage device; and a processor configured to control a display to display user interface (UI) screens for managing a content to be displayed on the digital signage device and schedules sequentially, configured to combine information input from each of the UI screens displayed sequentially and configured to transmit the combined information to the digital signage device.

According to an aspect of another exemplary embodiment, there is provided a digital signage device, including: a storage; a communicator configured to perform communication with a user terminal device; a processor configured to, in response to display information which is generated by combining information input through a UI screen of the user terminal device and a content which is provided according to the display information being received from the user terminal device, store the received display information in the storage and display the content on a display device in real time based on the stored display information.

According to the above-described various exemplary embodiments, a user terminal device and a digital signage device may display UI screens for editing contents and managing display schedules and perform the operation of display a content by combining information input from each of the UI screens. Accordingly, a user may be provided with a method for displaying contents easily.

### BRIEF DESCRIPTION OF THE DRAWINGS

The above and/or other aspects of the disclosure will be more apparent by describing exemplary embodiments with reference to the accompanying drawings, in which:

FIG. 1 is a view illustrating a system which sets a digital signage device according to an exemplary embodiment;

FIGS. 2A and 2B illustrate block diagrams illustrating configuration of a user terminal device according to exemplary embodiments;

FIGS. 3A-3C illustrate first UI screens for receiving shop information according to exemplary embodiments;

FIGS. 4A-4D illustrate second UI screens for editing contents according to exemplary embodiments;

FIGS. 5A and 5B illustrate third UI screens for managing display schedules according to exemplary embodiments;

FIG. 6 is a UI screen for receiving a content to be provided on a digital signage device according to an exemplary embodiment;

FIGS. 7A and 7B illustrate UI screens for changing a layout of a content according to exemplary embodiments;

FIG. 8 is a view provided to explain detection of a digital signage device and editing of a content according to an exemplary embodiment;

FIG. 9 is a flowchart provided to explain a method of controlling a user terminal device according to an exemplary embodiment;

FIG. 10 is a block diagram illustrating configuration of a digital signage device according to an exemplary embodiment;

FIG. 11 is a view provided to explain an operation of acquiring customer information by a digital signage device according to an exemplary embodiment; and

FIG. 12 is a flowchart provided to explain a method of controlling a digital signage device according to an exemplary embodiment.

### DETAILED DESCRIPTION

The exemplary embodiments of the disclosure may be diversely modified. Accordingly, specific exemplary embodiments are illustrated in the drawings and are described in detail in the detailed description. However, it is to be understood that the present disclosure is not limited to a specific exemplary embodiment, but includes all modifications, equivalents, and substitutions without departing from the scope and spirit of the present disclosure. Also, well-known functions or constructions are not described in detail because they would obscure the disclosure with unnecessary detail.

The terms used in this specification will be briefly explained and the present disclosure will be explained in detail.

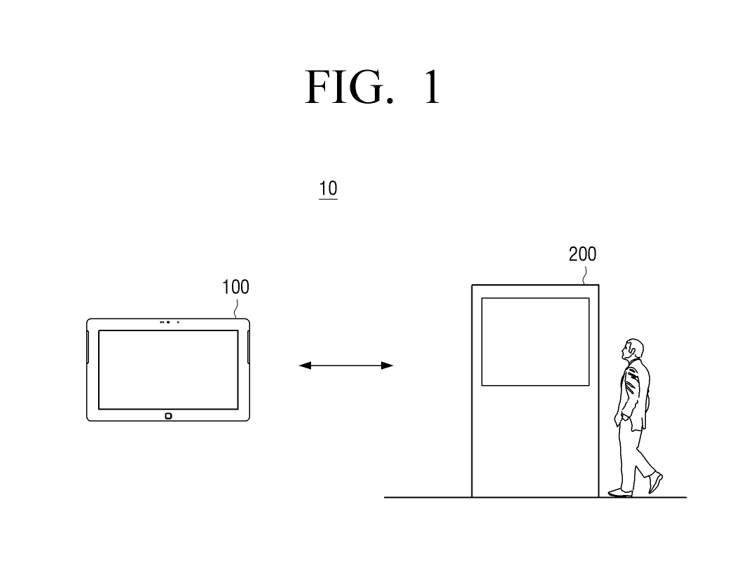

FIG. 1 is a view illustrating a system 10 which sets a digital signage device according to an exemplary embodiment. As illustrated in FIG. 1, the system 10 for setting a digital signage device includes a user terminal device 100 and a digital signage device 200.

The user terminal device 100 may perform communication with the digital signage device 200. The user terminal device 100 may transmit a content to be provided on the digital signage device 200 and information regarding display schedules. Meanwhile, the user terminal device 100 may receive information regarding hardware specification of the digital signage device 200 and customers to be provided with contents from the digital signage device 200.

The user terminal device 100 may display a user interface (UI) for setting contents to be provided on the digital signage device 200 and information regarding display schedules. In addition, the user terminal device 100 may provide UIs in separate stages. For example, at first, the user terminal device 100 may provide a UI for inputting shop information, etc. Subsequently, if there is an input regarding shop information from a user, the user terminal device 100 may display a UI for providing candidate contents corresponding to the shop information. In addition, if there is an input for selecting a content from a user, the user terminal device 100 may provide a UI for setting display schedule of the corresponding content.

The user terminal device 100 may display UI screens sequentially, and transmit information which is generated by combining information input from each of the UI screens displayed sequentially to the digital signage device 200. The information which is generated by combining the information may include not only a content to be provided on the digital signage device 200, a display schedule but also tag information of the content, etc.

The digital signage device 200 may perform communication with the user terminal device 100 and display a content. Here, the digital signage refers to outdoor advertising using digital information display (DID), and means an outdoor billboard of which advertisement contents can be controlled through a communication network from a control center. In other words, the digital signage refers to outdoor advertising which can be controlled by a control center remotely in real time. However, hereinafter, an exemplary embodiment will focus on the feature that the digital signage device 200 is set and used using the system 10 for setting the digital signage device 200 rather than the feature of using real-time remote control by a control center. In other words, an exemplary embodiment will describe a case where a system is set by an individual rather than a case where a system is continuously managed by a large-scale management company or a specific enterprise.

The digital signage device 200 may perform communication with the user terminal device 100. The digital signage device 200 may receive information to be displayed from the user terminal device 100. Meanwhile, the digital signage device 200 may acquire customer information, etc., and transmit the acquired customer information and hardware specification, etc. of the digital signage device 200 to the user terminal device 100.

When receiving information to be displayed from a user terminal device, the digital signage device 200 may store the received information in a storage. The digital signage device 200 may display a content based on the stored information. For example, the digital signage device 200 may display a content corresponding to current time from among the stored information. In addition, the digital signage device 200 may display a content in real time, and change and display the content based the change of a time zone or information on a customer who is watching the digital signage device 200.

FIG. 1 illustrates that the user terminal device 100 is a tablet PC, but the exemplary embodiment is not particularly limited. The user terminal device 100 may be, for example, a smart phone, a desktop PC, or any other device capable of performing communication with the digital signage device 200.

In addition, FIG. 1 illustrates that the digital signage device 200 is an electronic display board on the street, but the exemplary embodiment is not particularly limited. The digital signage device 200 may be, for example, a large-scale display device, a plurality of LEDs installed on the outer wall of a building, or any device capable of providing information to unidentified customers.

As described above, the user terminal device 100 may provide a UI for initial setting of the digital signage device 200 and accordingly, a user may set and manage the digital signage device 200 without using a specific enterprise.

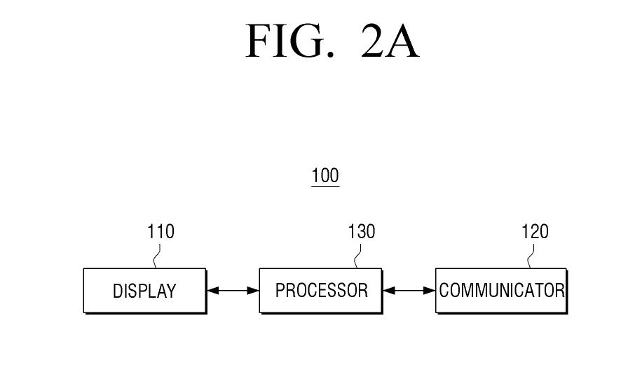

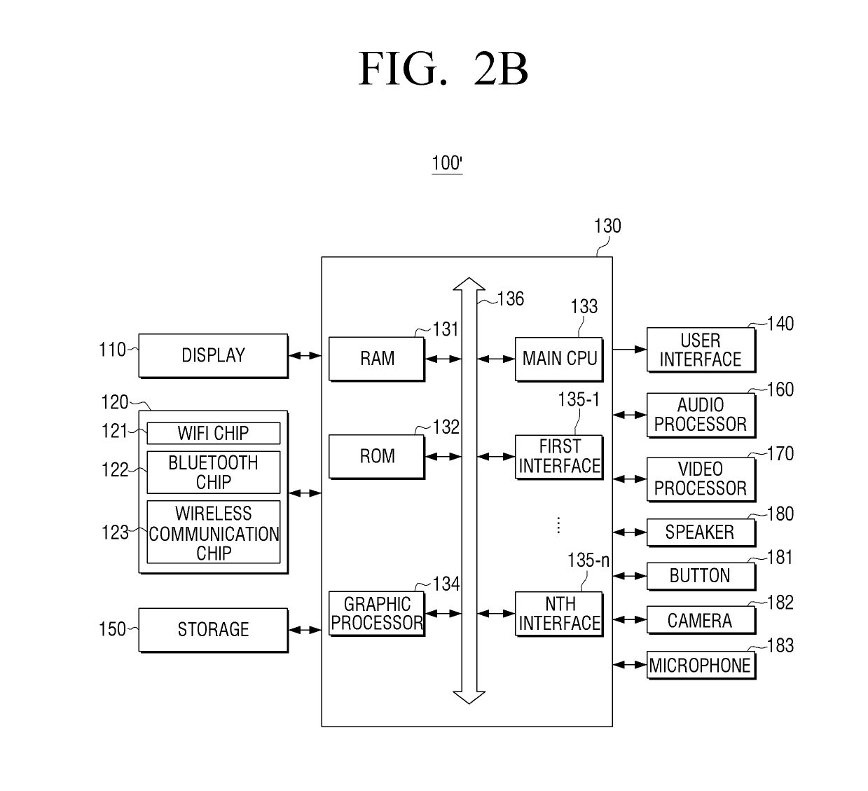

FIG. 2A is a block diagram illustrating configuration of the user terminal device 100 according to an exemplary embodiment. FIG. 2B is a block diagram illustrating configuration of a user terminal device 100′ according to an exemplary embodiment.

According to FIG. 2A, the user terminal device 100 includes a display 110, a communicator 120 and a processor 130.

FIG. 2A illustrates various elements in a comprehensive manner presuming that the user terminal device 100 is an apparatus having various functions such as a display function, a communication function, a control function, etc. Accordingly, depending on exemplary embodiments, some of the elements illustrated in FIG. 2A may be omitted or changed, or other elements may be added.

The display 110 may display UI screens for editing/inputting a content by a user to be provided on the digital signage device 200 and managing display schedules sequentially under the control of the processor 130. For example, the display 110 may display a UI for receiving shop information, a UI for receiving a content to be displayed, and a UI for receiving a display schedule. However, the exemplary embodiment is not limited thereto. For example, and the display 110 may display a UI for receiving ID, password, etc. for connecting to the digital signage device 200.

The display 110 may be realized as a Liquid Crystal Display Panel (LCD), an Organic Light Emitting Diodes (OLED), etc., but this is not limited thereto. In addition, the display 110 may be realized as a flexible display, a transparent display, etc. depending on exemplary embodiments.

The communicator 120 performs communication with the digital signage device 200.

Specifically, the communicator 120 may receive information on device attributes from the digital signage device 200. For example, the received information may be information regarding the manufacturer, model name, and location information regarding a device. In addition, the communicator 120 may combine information which is set by a user and transmit the combined information to the digital signage device 200. For example, the transmitted information may be information regarding a content to be provided, a display schedule, etc.

Meanwhile, the communicator 120 may perform unilateral or bilateral communication with respect to the digital signage device 200. When unilateral communication is performed, the communicator 120 may transmit a signal to the digital signage device 200. When bilateral communication is performed, the communicator 120 may receive a signal from the digital signage device 200 and transmit a signal to the digital signage device 200.

The processor 130 may combine information input from each of the UI screens which are displayed sequentially and transmit the combined information to the digital signage device 200.

Here, the processor 130 may display a first UI screen for receiving shop information regarding a shop related to a content to be provided on the digital signage device 200, a second UI screen for editing a content, and a third UI screen for managing the display schedule of a content sequentially.

In particular, if shop information is input on the first UI screen, the processor 130 may provide candidate contents related to the input shop information on the second UI screen, and if at least one content is selected from among the candidate contents provided on the second UI screen, may display a basic display schedule management screen which is generated by applying a predetermined schedule template corresponding to the input shop information to the selected content on the third UI screen.

In addition, if customer information which is acquired from the digital signage device 200 is received, the customer information received on the second UI screen and candidate contents related to the input shop information may be provided.

In other words, the processor 130 may display each of the first UI screen, the second UI screen, and the third UI screens as an independent UI screen, but as described above, may change the current UI screen to the subsequent UI screen based on the information input on each of the UI screens and display the screen.

Meanwhile, a UI screen may include a first area 110A for receiving a user command and a second area 110B for providing a preview regarding a screen to be provided on the digital signage device 200. In this case, the processor 130 may display on the second area 110B a preview screen where information input on the first screen is applied to a predetermined layout. In addition, the processor 130 may change a layout automatically according to a user command, and display a preview screen where input information is applied to the changed layout.

Meanwhile, if the digital signage device 200 is detected within a predetermined scope from the user terminal device 100, the processor 130 may provide information regarding the detected digital signage device 200, and if a predetermined user command regarding the digital signage device 200 is input, may display a UI screen for editing display schedule information received from the digital signage device 200.

In addition, the processor 130 may provide a content to correspond to display attributes of the digital signage device 200 based on digital attributes information corresponding to the model information of the digital signage device 200. For example, if the resolution of a display of the digital signage device 200 is high definition (HD) based on the model information, the processor 130 may display a UI screen including only those contents of which resolution is HD.

According to FIG. 2B, the user terminal device 100′ includes the display 110, the communicator 120, the processor 130, a user interface 140, a storage 150, an audio processor 160, a video processor 170, a speaker 180, a button 181, a camera 182, and a microphone 183. The elements of FIG. 2B which are overlapped with those in FIG. 2A will not be described in detail.

The processor 130 controls the overall operations of the user terminal device 100 using various programs stored in the storage 150.

Specifically, the processor 130 includes a RAM 131, a ROM 132, a main CPU 133, a graphic processor 134, first to nth interface 135-1˜135-n, and a bus 136.

The RAM 131, the ROM 132, the main CPU 133, the graphic processor 134, the first to the nth interface 135-1˜135-n, etc. may be interconnected through the bus 136.

The first to the nth interface (135-1 to 135-n) are connected to the above-described various elements. One of the interface may be network interface which is connected to an external apparatus via network.

The main CPU 133 accesses the storage 150, and performs booting using an Operating System (O/S) stored in the storage 150. In addition, the main CPU 133 performs various operations using various programs stored in the storage 150.

The ROM 132 stores a set of commands for system booting. If a turn-on command is input and thus, power is supplied, the main CPU 133 copies O/S stored in the storage 150 in the RAM 131 according to a command stored in the ROM 132, and boots a system by executing the O/S. When the booting is completed, the main CPU 133 copies various application programs stored in the storage 150 in the RAM 131, and executes the application programs copied in the RAM 131 to perform various operations.

The graphic processor 134 generates a screen including various objects such as an icon, an image, a text, etc. using an computing unit (not shown) and a rendering unit (not shown). The computing unit computes property values such as coordinates, shape, size, and color of each object to be displayed according to the layout of the screen using a control command received from an input unit. The rendering unit generates a screen with various layouts including objects based on the property values computed by the computing unit. The screen generated by the rendering unit is displayed in a display area of the display 110.

Meanwhile, the operations of the above-described processor 130 may be performed by a program stored in the storage 150.

The storage 150 stores various data such as Operating System (O/S) software module to drive the display apparatus 100, information on various UI screens, various control information, various contents, model information on various digital signage devices 200, etc.

In this case, the processor 130 may display UI screens for setting a content to be provided on the digital signage device 200 and a display schedule sequentially based on information stored in the storage 150.

The user interface 140 receives various user interactions. If the user terminal device 100 is realized as a touch-based portable device, the user interface 140 may be implemented by using a touch-based portable terminal, the user interface 130 may be implemented in the form of a touch screen forming a mutual layer structure with a touch pad. In this case, the user interface 140 may be used as the above-described display 110.

A touch sensor (not illustrated) may be implemented by using a capacitive type or a resistive type of sensor. The capacitive type calculates touch coordinates by detecting minute electricity excited in a user's body when a part of the user's body touches the surface of the display, using a dielectric substance coated on the surface of the display. The resistive type includes two electrode plates embedded in the user terminal device 100, and when the user touches the screen, calculates touch coordinates by detecting an electric current flowing due to contact between upper and lower plates at the touched point. In addition, infrared beam, surface acoustic wave, integral strain gauge, piezo electric, etc. may be used to detect a touch interaction.

The audio processor 160 is an element which processes audio data. The audio processor 160 may perform various processing operations such as decoding, amplification, noise filtering, etc. with respect to the audio data.

The video processor 170 is an element for processing the video data. The video processor 170 may perform various image processing operations such as decoding, scaling, noise filtering, frame rate conversion, resolution conversion, etc. with respect to the video data.

The speaker 180 is an element for outputting not only various audio data processed by the audio processor 160 but also various alarm sounds, voice messages, etc.

The button 181 may include various types of buttons such as a mechanical button, a touch pad, a wheel, etc. formed on a certain area of the user terminal device 100, such as a front surface, a side surface, and a rear surface of the exterior of the body of the user terminal device 100.

The camera 182 is an element for photographing a still image or a moving image under the control of the user. The camera 182 may include a plurality of cameras such as a front surface camera and a rear surface camera. The microphone 183 is an element for receiving an input of a user voice or other sounds and converting the user voice or sound into audio data.

Hereinafter, the basic configuration and various exemplary embodiments will be explained for easy understanding of the present disclosure.

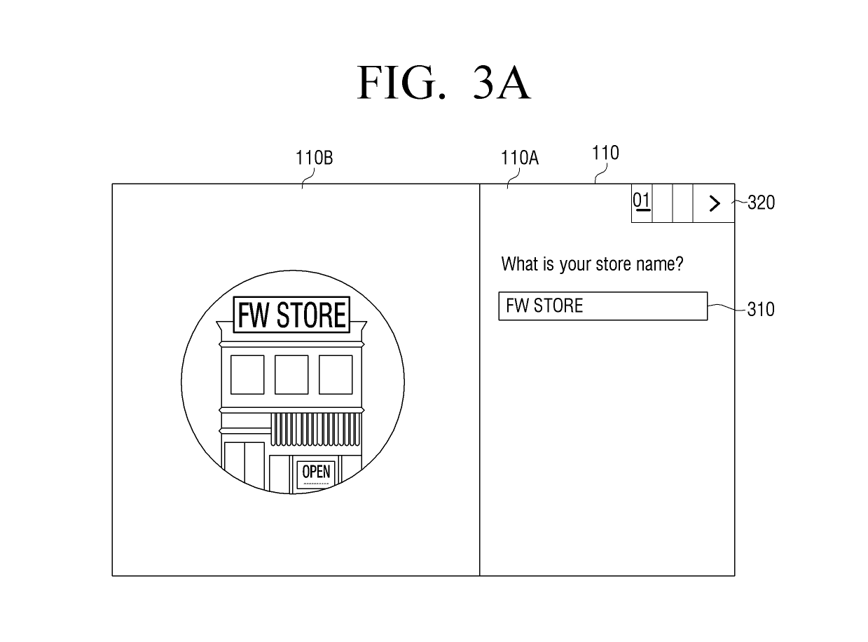

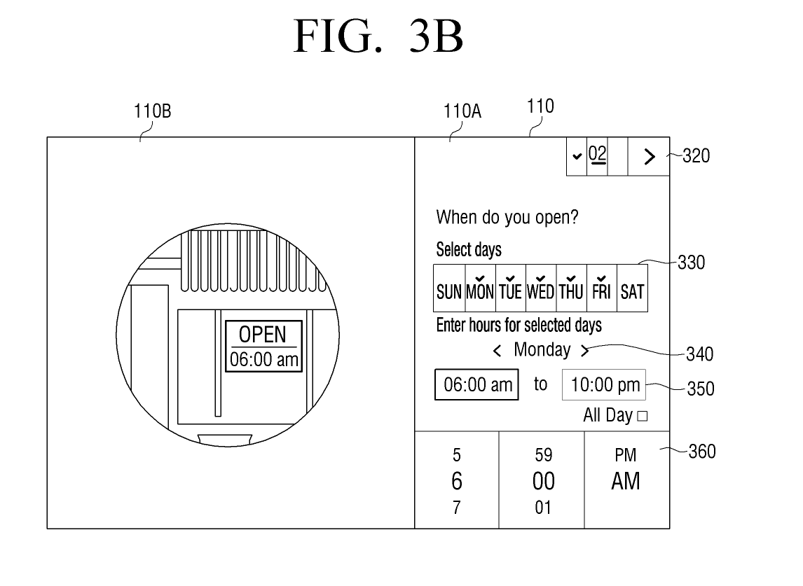

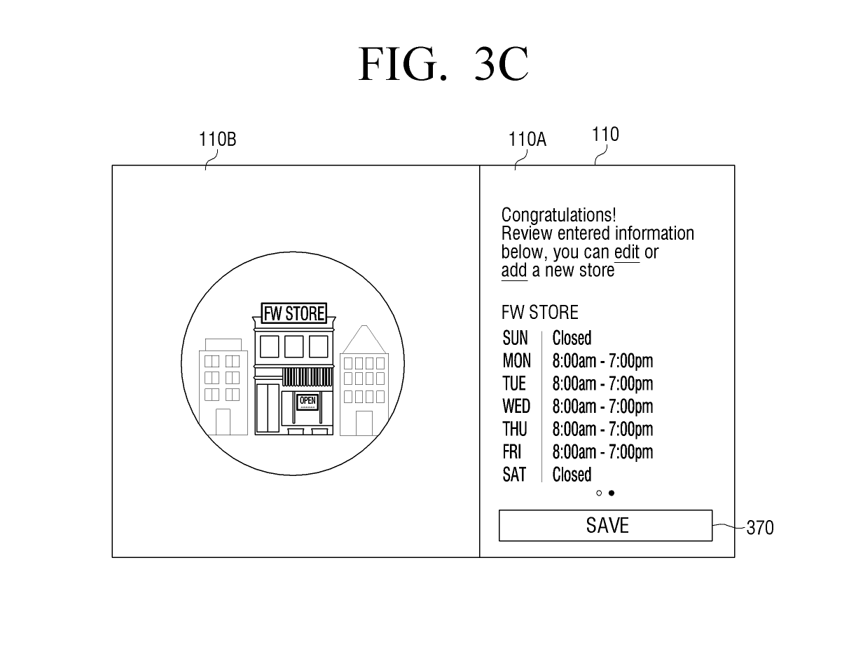

FIGS. 3A-3C illustrate first UI screens for receiving shop information according to exemplary embodiments.

According to an exemplary embodiment in FIG. 3A, the processor 130 may control the display 110 to display a UI screen for receiving a shop name from among shop information related to a content to be provided on the digital signage device 200.

The processor 130 may control the display 110 to display a UI screen including a first area 110A for receiving a user command and a second area 110B for providing a preview regarding a screen to be provided on the digital signage device 200. In addition, the processor 130 may control the display 110 to display an area 310 for inputting a shop name and a GUI 320 for proceeding to the next stage on the first area 110A.

If a shop name is input on the area 310 for receiving a shop name, the processor 130 may provide a preview with the shop name on the second area 110B. The processor 130 may control the display 110 to provide a preview with respect to the input shop name in real time, but is not limited thereto. For example, the processor 130 may provide a preview when a user inputs a predetermined button after all of the shop names have been input.

If there is an input with respect to the GUI 320 for proceeding to the next stage, the processor 130 may display the next UI screen.

In the above description, a UI screen including the first area 110A for receiving a user command and the second area 110B for providing a preview with respect to a screen to be provided on the digital signage device 200 is displayed, but the exemplary embodiment is not limited thereto. For example, the processor 130 may control the display 110 to display only the first area 110A for receiving a user command, and may not provide a preview. Alternatively, the processor 130 may control the display 110 to display only the second area 110B for providing a preview, and may receive information regarding a shop name directly using the second area 110B. FIG. 3A illustrates that the above-mentioned two areas are displayed separately.

According to an exemplary embodiment of FIG. 3B, the processor 130 may control the display 110 to display a UI screen for receiving business hours, etc. from among shop information related to a content to be provided on the digital signage device 200.

The processor 130 may control the display 110 to display a menu 330 for selecting a day, a menu 340 for indicating a day to designate business hours, and menus 350, 360 for designating business hours on the first area 110A. If there is a user input with respect to each of the menus, the processor 130 may control the display 110 to display the input contents on the second area 110B on the left side.

If there is an input with respect to the GUI 320 for proceeding to the next stage, the processor 130 may control the display 110 to display the next UI screen.

According to FIG. 3C, the processor 130 may control the display 110 to display a UI screen for final confirmation regarding shop information related to a content to be provided on the digital signage device 200.

The processor 130 may arrange and control the display 110 to display shop information which is input from each of the UI screens previously. The processor 130 may control the display 110 to display information regarding a shop name and business hours per day on the first area 110A.

The processor 130 may control the display 110 to provide “edit” menu and “add” menu to edit the input shop information or add information regarding a new shop. For example, if a user selects the “edit” menu, the processor 130 may provide appropriate UI screens for the user to edit information that the user has input on each of the UI screens in the UI screen illustrated in FIG. 3A or FIG. 3B and display the UI screen. If the user selects the “add” menu, the processor 130 may control the display 110 to display an initialized UI screen illustrated in FIG. 3A.

The processor 130 may control the display 110 to provide a “SAVE” button 370 to proceed to the next stage when there is no problem with the input shop information. If the user clicks the “SAVE” button 370, the processor 130 may store the information regarding the shop information and display a second UI screen for editing contents.

Meanwhile, in the above description, the processor 130 divides the first UI screen and controls the display 110 to provide screens by stages, but the exemplary embodiment is not limited thereto. For example, the processor 130 may receive information regarding a shop name and business hours using a single UI screen.

In addition, in the above description, the processor 130 receives information regarding a shop name and business hours through the first UI screen, but the exemplary embodiment is not limited thereto. For example, the processor 130 may receive not only information regarding a shop name and business hours but also information regarding the type of shop and location additionally through the first UI screen.

The processor 130 may associate SNS account information with the digital signage device 200. In other words, the processor 130 may store SNS account information which is input initially in the specific digital signage device 200 and subsequently, request the SNS account information to edit contents, etc. of the corresponding digital signage device 200.

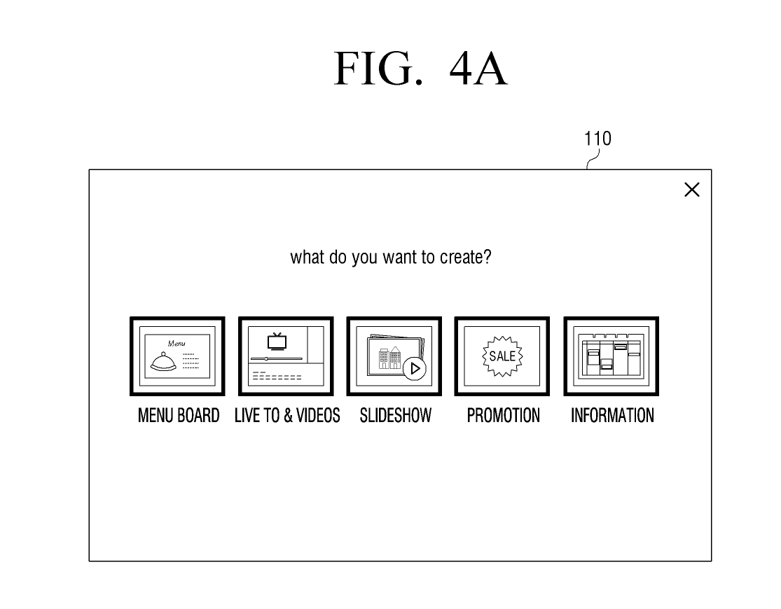

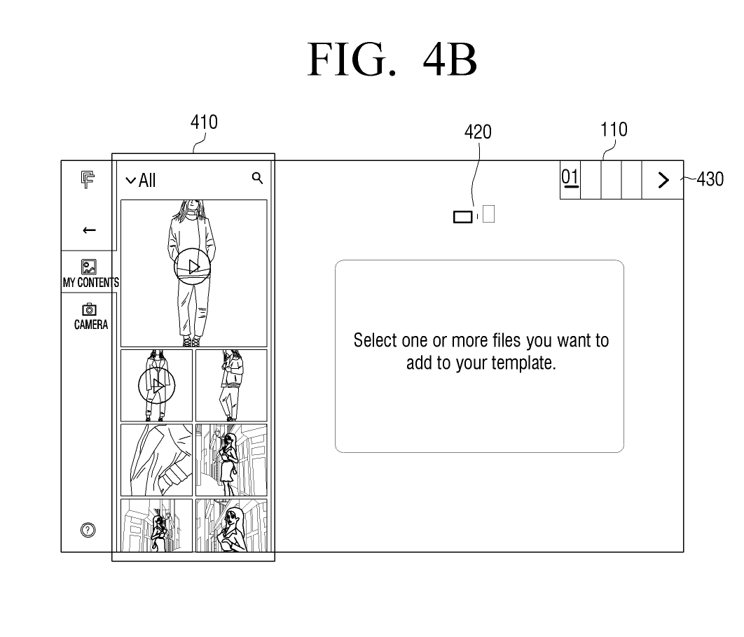

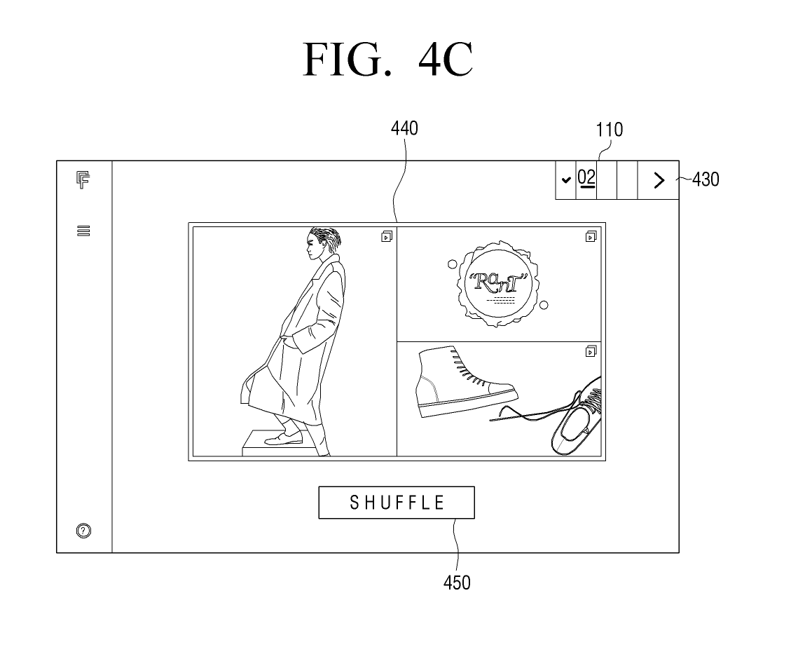

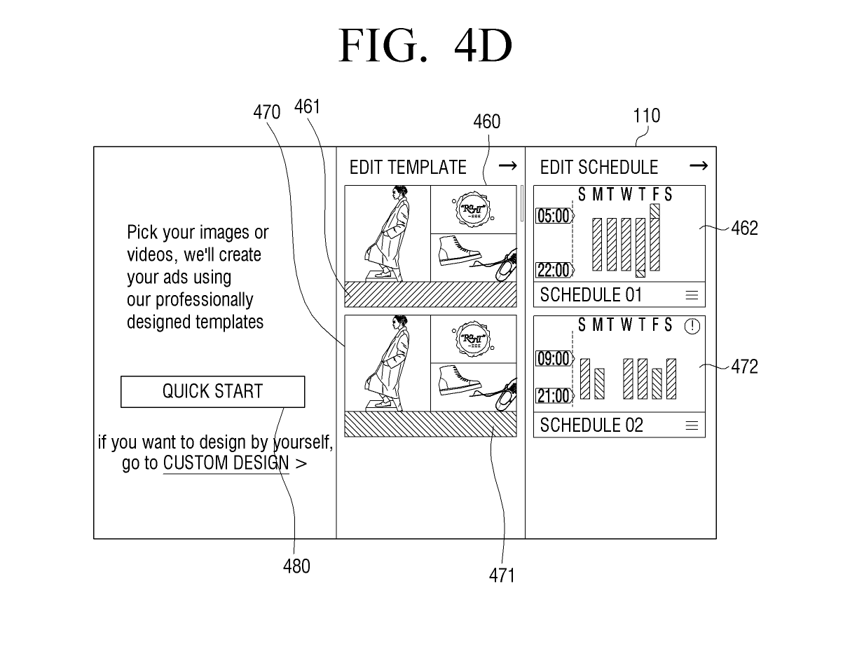

FIGS. 4A-4D illustrate second UI screens for editing contents according to exemplary embodiments.

According to FIG. 4A, the processor 130 may control the display 110 to display a UI screen for receiving a display purpose of a content to be provided on the digital signage device 200.

The processor 130 may control the display 110 to display a display purpose which may include providing a food menu, an image, a slide show, an advertisement and information. According to a display purpose, the processor 130 may control the display 110 to provide a UI screen which is displayed subsequently differently. For example, if a user selects food, the processor 130 may control the display 110 to display a UI screen for receiving a food image, the price or ingredients of the corresponding food, etc. If a user selects a slide show, the processor 130 may control the display 110 to display a UI screen for receiving a plurality of slides for a slide show. Meanwhile, FIG. 4A illustrates five display purposes, but the exemplary embodiment is not limited thereto. For example, the processor 130 may control the display 110 to illustrate less number of display purposes, or may illustrate more display purposes by adding the purposes of providing news, etc. Hereinafter, it is assumed that a user selects an advertisement as a display purpose.

According to FIG. 4B, the processor 130 may control the display 110 to display a UI screen for receiving a content to be provided on the digital signage device 200.

If shop information is input on the above-described first UI screen, the processor 130 may control the display 110 to provide candidate contents 410 related to the shop information which is input on the second UI screen. For example, if a user inputs a clothing shop as the shop information, the processor 130 may provide contents related to clothing as the candidate contents 410. However, the exemplary embodiment is not limited thereto, and the processor 130 may provide candidate contents which have nothing to do with the shop information input on the first UI screen.

The processor 130 may provide the candidate contents 410 by providing “MY CONTENTS” menu or “CAMERA” menu. For example, if a user selects the “MY CONTENTS” menu, the processor 130 may display contents stored in the user terminal device 100. The “MY CONTENTS” menu may be contents which are provided by the user terminal device 100 itself, or contents which the user copied from another electronic apparatus and stored in the user terminal device 100. However, the exemplary embodiment is not limited thereto, and the processor 130 may provide contents which are received/transmitted through the user's SNS account or stored in a server.

In addition, the user terminal device 100 may store data regarding the number of contents which are selected by other users according to a display purpose, etc. In this case, the processor 130 may control the display 110 to provide the most-frequently selected contents as candidate contents according to a display purpose.

If a user selects the “CAMERA” menu, the processor 130 may provide an image which is photographed in real time using the camera 182 of the user terminal device 100.

The processor 130 may control the display 110 to provide a GUI 420 for determining a direction in which a content is displayed longer between a horizontal direction and a vertical direction according to a display ratio of the digital signage device 200. However, the exemplary embodiment is not limited thereto and the processor 130 may control the display 110 to display a content in the form of a regular square. If a user selects a content in the form of a regular square and thus, the ratio of the content is different from the display ratio of the digital signage device 200, the content may be extended and displayed, or a space may be displayed in a dark color.

The processor 130 may control the display 110 to display a GUI 430 for proceeding to the next stage. If there is an input with respect to the GUI 430 for proceeding to the next stage, the processor 130 may display a selected content in a predetermined layout.

Referring to FIG. 4C, the processor 130 may control the display 110 to display a UI screen for changing a layout of a selected content.

The processor 130 may control the display 110 to display a selected content to have a user's final confirmation. When only one content is selected, the processor 130 may display the selected content only. If a plurality of contents are selected, the processor 130 may control the display 110 to display the plurality of contents in a predetermined layout. The processor 130 may control the display 110 to display a GUI 450 for changing a layout. If there is an input with respect to the GUI 450 for changing a layout, the processor 130 may control the display 110 to change the layout and display a plurality of contents, which will be described later in detail.

Meanwhile, the processor 130 may control the display 110 to provide a menu for editing a selected content. For example, the processor 130 may control the display 110 to provide a menu for changing an image crop or rotation of a selected content, adding a text or a sticker, changing a background, etc.

If there is an input with respect to the GUI 430 for proceeding to the next stage, the processor 130 may display a screen illustrating a content and a schedule.

Referring to FIG. 4D, the processor 130 may control the display 110 to display a UI screen for editing a content and a schedule.

The processor 130 may control the display 110 to provide a Quick Start menu 480 on the left side of the UI screen. If the Quick Start menu 480 is selected, the UI screen illustrated in FIG. 3A may be displayed. In other words, a user may newly select a content to be displayed on the digital signage device 200 using the Quick Start menu 480 and write a schedule. However, the exemplary embodiment is not limited thereto, and the processor 130 may control the display 110 to provide a Custom Design menu on the lower side of the Quick Start menu 480. If a user selects the Custom Design menu, the processor 130 may control the display 110 to provide nothing but a blank page. For example, the processor 130 may control the display 110 to not provide a shop image of the preview area illustrated in FIG. 3A and instead, a user may set a shop image by photographing an image in person, by downloading an image, etc.

The processor 130 may control the display 110 to display a content layout 460 which has been prepared previously at a center area of a UI screen. The processor 130 may control the display 110 to display not only the content layout 460 which is prepared by a user input up until FIG. 4C but also a content layout 470 which is made previously and transmitted to the digital signage device 200. Accordingly, the user may reuse the content layout 470 which has been prepared previously.

If one of the displayed content layouts 460, 470 is selected, the processor 130 may display a UI screen for changing the corresponding content layout. For example, if a user selects the content layout 470, the processor 130 may display the UI screen illustrated in FIG. 4A. Here, the processor 130 may control the display 110 to display a display purpose selected by the user distinctively from other display purposes on the UI screen. If there is an input with respect to the GUI 430 for proceeding to the next stage, the processor 130 may control the display 110 to display a UI screen for receiving a content. In this case, the processor 130 may control the display 110 to display the selected content distinctively from non-selected contents.

The processor 130 may control the display 110 to display a display schedule on the right side of a UI screen. For example, the processor 130 may prepare and control the display 110 to display an arbitrary display schedule based on a display schedule 462 which has been prepared previously and shop information. In addition, the processor 130 may prepare and control the display 110 to display a predetermined display schedule 472. For example, if business hours of a clothing shop is generally 09:00˜21:00, the processor 130 may prepare and control the display 110 to display a display schedule corresponding to the business hours of 09:00˜21:00.

Meanwhile, a plurality of content layouts may be associated with a display schedule. For example, the plurality of content layouts 460, 470 may be associated with the display schedule 462. In this case, the processor 130 may control the display 110 to display the color of the time section for each day in the display schedule 462 to be the same as the color of the lower part of the corresponding content layout. Referring to FIG. 4D, the content layout 460 where the color 461 of the lower part of the content layout is the same may be displayed for most of the time of the display schedule 462, and the content layout 470 where the color 471 of the lower part of the content layout is the same may be displayed for some time of Thursday and Friday. However, the exemplary embodiment is not limited thereto, and the processor 130 may control the display 110 to indicate a corresponding layout and a display schedule using numbers, etc. rather than colors.

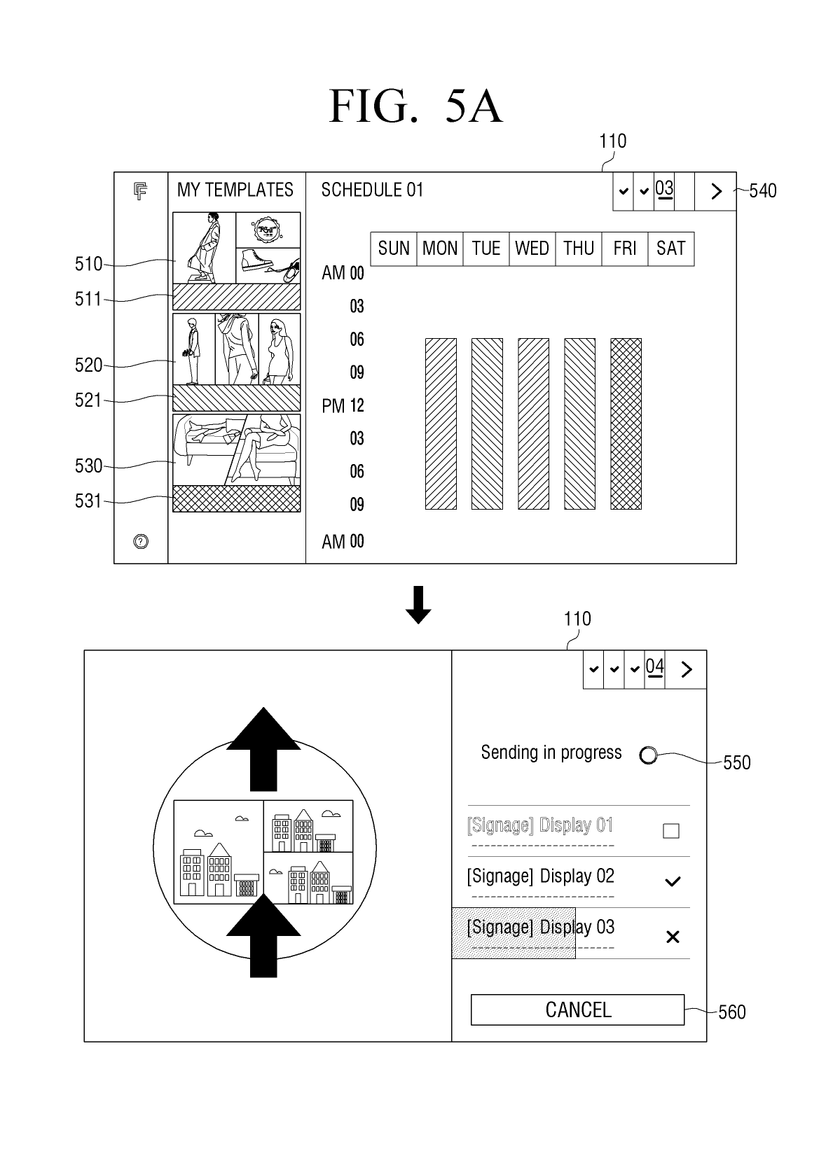

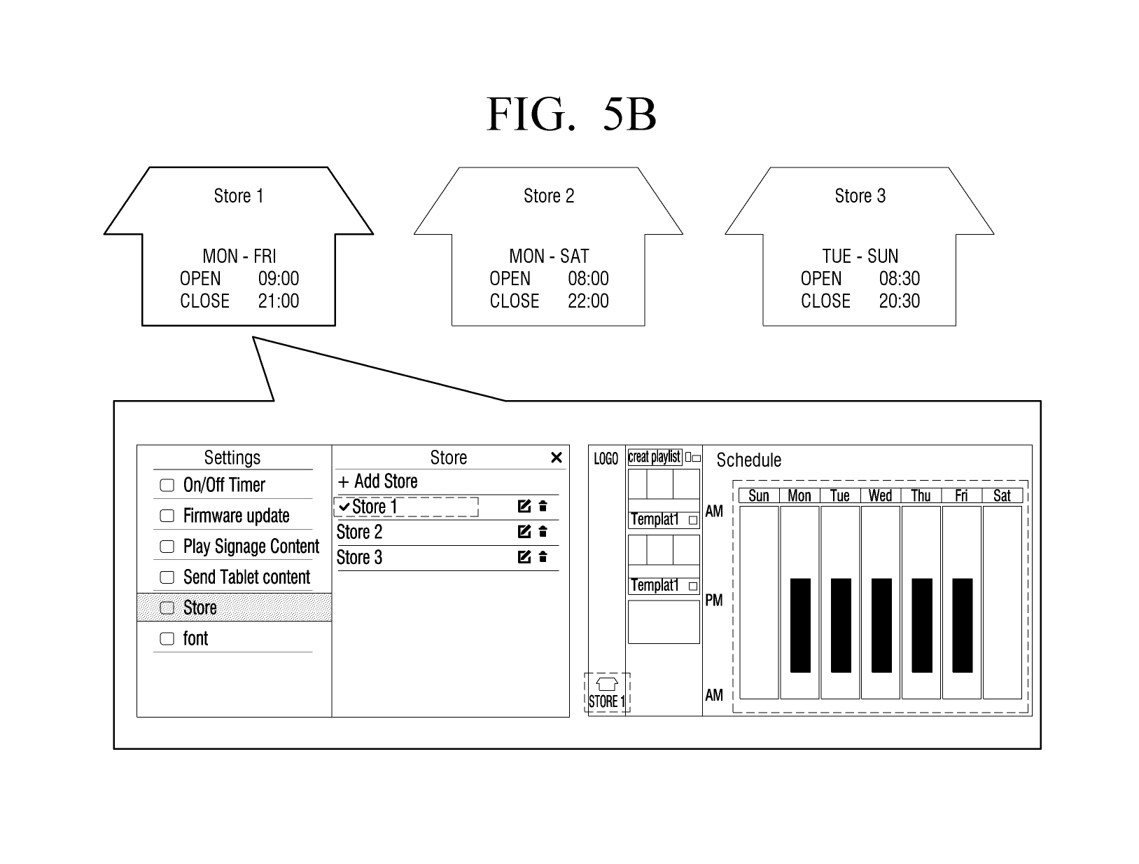

If one of the display schedules 462, 472 which are displayed is selected, the processor 130 may control the display 110 to display a UI screen for changing the corresponding display schedule, which has been described above with reference to FIGS. 5A and 5B.

Meanwhile, the processor 130 may provide contents in accordance with the display attributes of the digital signage device 200 based on display attributes corresponding to model information of the digital signage device 200. As described above, the processor 130 may provide contents in consideration of the resolution and the screen ratio of a display of the digital signage device 200. In particular, the processor 130 may not only provide contents which correspond to display attributes but also convert contents to correspond to display attributes and display the converted contents. However, the exemplary embodiment is not limited thereto, and the processor 130 may control the display 110 to provide a UI screen in consideration of a category of business where the corresponding model is used.

The model information of the digital signage device 200 may be stored in the storage 150 of the user terminal device 100, or may be received from a server. A user may edit contents and generate a display schedule based on the model information of the digital signage device 200, which is provided by the processor 130. However, the exemplary embodiment is not limited thereto, and the processor 130 may perform communication with the digital signage device 200 to receive and provide model information directly.

FIGS. 5A and 5B illustrate third UI screens for managing display schedules according to exemplary embodiments.

If at least one of candidate contents which are provided on the second UI screen is selected, the processor 130 may control the display 110 to display a basic display schedule management screen which is generated by applying a predetermined schedule template corresponding to input shop information to the selected content on the third UI screen. However, the exemplary embodiment is not limited thereto, and the processor 130 may control the display 110 to display the third UI screen without reflecting shop information. In this case, only a day and a layout list of the selected content may be displayed on the third UI screen.

Referring to FIG. 5A, the processor 130 may control the display 110 to display a plurality of content layouts 510, 520, 530 according to a predetermined display schedule. FIG. 5A illustrates the plurality of content layouts 510, 520, 530 assuming that a shop operates between 06:00 AM and 09:00 PM from Monday to Friday. In addition, the processor 130 may control the display 110 to display the first content layout 510 on Monday and Wednesday, the second content layout 520 on Tuesday and Thursday, and the third content layout 530 on Friday. The processor 130 may control the display 110 to display the color of the lower parts 511, 521, 531 of each content layout to be the same as the color of a corresponding schedule.

If there is an input to change the time of a display schedule, the processor 130 may extend or reduce the time according to the input, and may not display a content on a specific day. In other words, the digital signage device 200 may display contents according to a user's setting even during non-business hours.

If there is an input to change the layout of a content which is to be displayed, the processor 130 may change the lower part of the selected content and the color of some of the selected display schedule.

Meanwhile, in the above description, a plurality of selected contents are displayed according to a predetermined layout, but this is only an example. For example, a plurality of contents included in a single layout may be displayed sequentially.

The processor 130 may control the display 110 to display a GUI 540 for proceeding to the next stage. If there is an input with respect to the GUI 430 for proceeding to the next stage, the processor 130 may control the display 110 to display a UI screen for transmitting information which is generated by combining information input on each of the first to the third UI screens displayed sequentially to the digital signage device 200.

The processor 130 may control the display 110 to display a GUI 550 for displaying that a transmission operation is being performed, and after the transmission operation is completed, the form of the GUI may be changed. In addition, the processor 130 may provide a “CANCEL” menu 560, and if the “CANCEL” menu 560 is selected, the processor 130 may transmit a control command to stop the transmission operation and remove the information which has already been transmitted to the digital signage device 200.

Meanwhile, the processor 130 may add tag information to a content before the content is transmitted to the digital signage device 200. For example, if a selected content is related to women clothing, the processor 130 may add “woman” and “clothing” to the corresponding content as tag information before transmitting the information. However, the exemplary embodiment is not particularly limited, and the processor 130 may add information regarding age and race as tag information and transmit the information.

FIG. 5B illustrates a case where a plurality of shops are registered. If a plurality of shops are registered, the processor 130 may transmit information which is generated by combining information which is input on each of the first to the third UI screens displayed sequentially to the digital signage device 200 corresponding to a currently-selected shop.

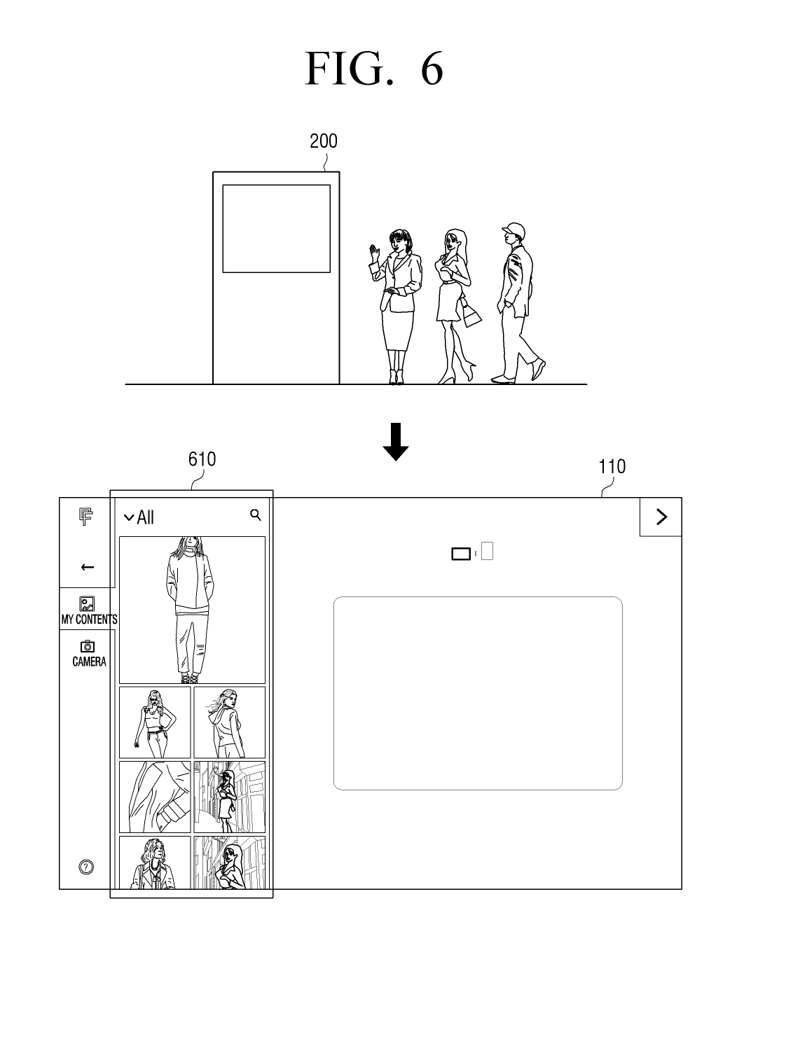

FIG. 6 is a UI screen for receiving a content to be provided on the digital signage device 200 according to an exemplary embodiment.

Referring to FIG. 6, the processor 130 may receive customer information which is acquired from the digital signage device 200. The digital signage device 200 which will be described later may detect customers around the digital signage device 200. The digital signage device 200 may analyze the detected information to acquire customer information, which will be described later in detail.

The digital signage device 200 detects one man and two women, and transmit such customer information to the user terminal device 100. The user terminal device 100 may provide customer information received on the second UI screen and a candidate content related to shop information which has been input. For example, the user terminal device 100 may provide a candidate content 610 related to women based on the detected two women. In particular, if shop information indicates that the shop is a clothing shop, the processor 130 may provide the candidate content 610 which is related to women and clothing. However, the exemplary embodiment is not limited thereto, and the processor 130 may control the display 110 to provide a candidate content related to men and clothing, but provide the candidate content 610 related to women and clothing preferentially.

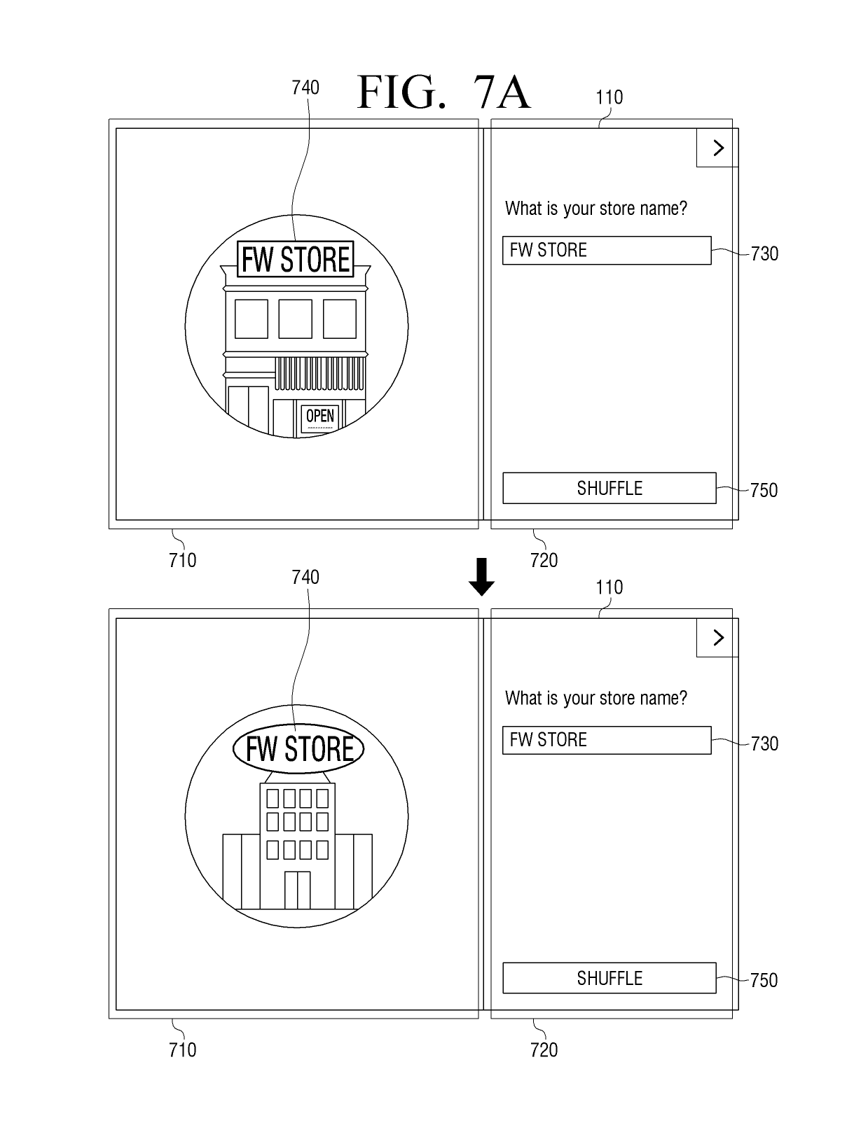

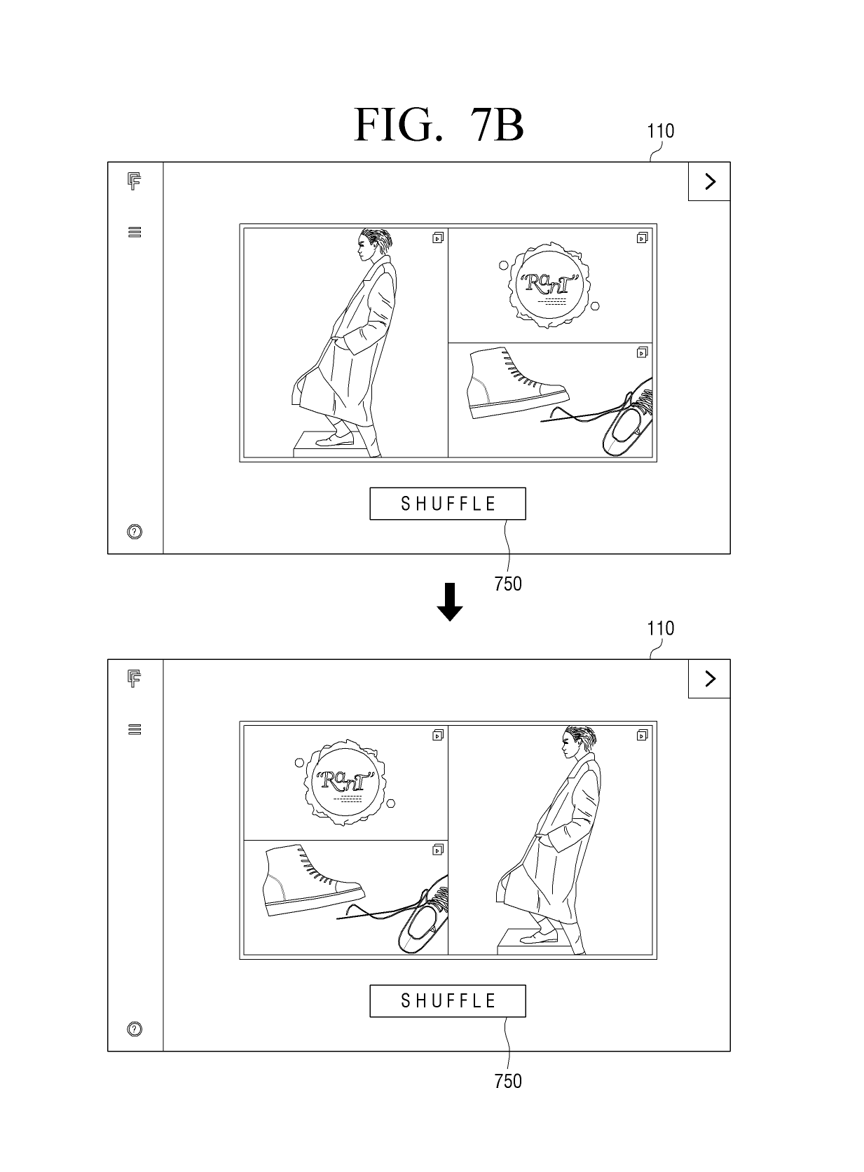

FIGS. 7A and 7B are UI screens for changing a layout of a content according to exemplary embodiments.

Referring to FIG. 7A, the processor 130 may control the display 110 to display a UI screen for receiving a shop name. As described above, the UI screen may include a first area 720 for receiving a user command and a second area 710 for providing a preview regarding a screen to be provided on the digital signage device 200.

The processor 130 may control the display 110 to display an area 730 for receiving a shop name of the first area 720, and display a preview screen where the information input on the area 730 for receiving a shop name is applied to a predetermined template on the second area 710.

In addition, the processor 130 may control the display 110 to display a “SHUFFLE” menu 750 on the first area 720. If there is a user input with respect to the “SHUFFLE” menu 750, the processor 130 may change a template automatically, and display a preview screen where input information is applied to the changed template. For example, as illustrated in FIG. 7A, the processor 130 may change a template illustrating a small building to a template illustrating a building.

Referring to FIG. 7B, the processor 130 may control the display 110 to display a UI screen for changing the layout of a selected content.

The processor 130 may control the display 110 to display the “SHUFFLE” menu 750 for changing a layout. If there is a user input with respect to the “SHUFFLE” menu 750, the processor 130 may control the display 110 to change a template automatically, and display a preview screen where input information is applied to the changed template. For example, as illustrated in FIG. 7B, the processor 130 may change the arrangement of contents.

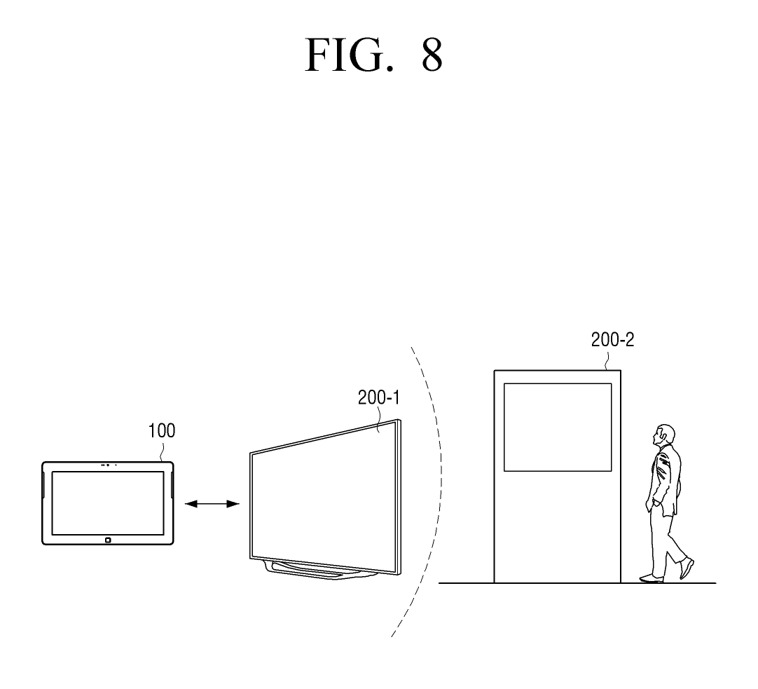

FIG. 8 is a view provided to explain detection of the digital signage device 200 and editing of a content according to an exemplary embodiment.

Referring to FIG. 8, the user terminal device 100 may detect a digital signage device 200-1 which is within a predetermined distance, and may not detect a digital signage device 200-2 which is not within the predetermined distance. The user terminal device 100 may detect the digital signage device 200-1 within the predetermined distance using Bluetooth and WiFi Direct. Here, the predetermined distance may vary depending on communication standards.

Meanwhile, FIG. 8 illustrates that the user terminal device 100 detects one digital signage device 200-1, but the exemplary embodiment is not limited. For example, the user terminal device 100 may detect a plurality of digital signage devices within a predetermined distance.

If the digital signage device 200 is detected within a predetermined range from the user terminal device 100, the processor 130 may provide information regarding the detected digital signage device 200. For example, the processor 130 may control the display 110 to display a UI screen including a plurality of GUIs which represent each of a plurality of detected digital signage devices.

If a predetermined user command is input with respect to a detected digital signage device, the processor 130 may control the display 110 to display a UI screen for editing display schedule information received from the digital signage device. For example, if one of a plurality of GUIs is selected, the processor 130 may receive display schedule information from a digital signage device corresponding to the selected GUI and display a UI screen for editing the received display schedule information. However, this is only an example, and the processor 130 may control the display 110 to display a UI screen for editing display schedule information which is pre-stored in a digital signage device corresponding to the selected GUI instead of receiving display schedule information from the digital signage device corresponding to the selected GUI.

In the above description, only the digital signage device 200 close to the user terminal device 100 is detected, but this is only an example. For example, the user terminal device 100 may be connected to the Internet, or may detect and control only those devices which are connected to the Internet out of the digital signage device 200.

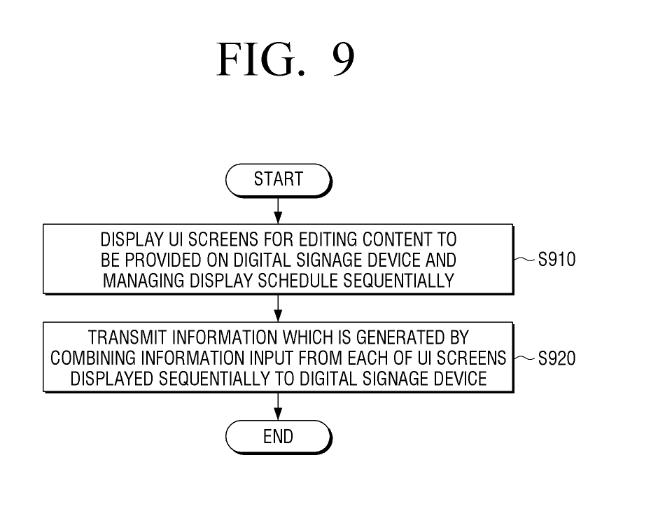

FIG. 9 is a flowchart provided to explain a method of controlling the user terminal device 100 according to an exemplary embodiment.

Referring to FIG. 9, a user terminal device displays UI screens for editing/inputting a content to be provided on a digital signage device and managing a display schedule sequentially (S910). Subsequently, the user terminal device transmits to the digital signage device information which is generated by combining information input from each of the UI screens that are displayed sequentially (S920).

In addition, the displaying step (S910) may include displaying a first UI screen for receiving shop information related to a content which is to be provided on a digital signage device, a second UI screen for editing a content and a third UI screen for managing a display schedule of a content sequentially.

The displaying step (S910) may include, when shop information is input on the first UI screen, providing candidate contents related to the input shop information on the second UI screen, and when one of the candidate contents provided on the second UI screen is selected, displaying a basic display schedule management screen which is generated by applying a predetermined schedule template corresponding to the input shop information to the selected content on the third UI screen.

In addition, the displaying step (S910) may include, when customer information acquired from the digital signage device is received, providing customer information received from the second UI screen and candidate contents related to the input shop information.

The UI screen may include a first area for receiving a user command and a second area for providing a preview regarding a screen to be provided on the digital signage device, and the displaying step (S910) may include displaying a preview screen where the information input on the first area is applied to a predetermined layout on the second area, changing the layout automatically according to a user command, and displaying a preview screen where the input information is applied to the changed layout.

In addition, when a digital signage device is detected within a predetermined range from a user terminal device, providing information regarding the detected digital signage device, and when a predetermined user terminal regarding the digital signage device is input, displaying a UI screen for editing display schedule information received from the digital signage device may be further included.

In addition, the displaying step (S910) may include providing a content to correspond to display attributes of the digital signage device based on display attributes information corresponding to model information of the digital signage device.

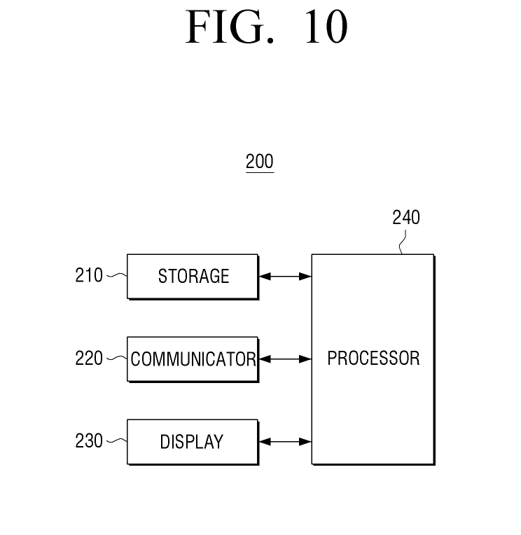

FIG. 10 is a block diagram illustrating configuration of the digital signage device 200 according to an exemplary embodiment.

Referring to FIG. 10, the digital signage device 200 includes a storage 210, a communicator 220, a display 230, and a processor 240.

Meanwhile, FIG. 10 illustrates various elements assuming that the digital signage device 200 is an apparatus having various functions such as a storage function, a communication function, a display function, a control function, etc. Accordingly, depending on exemplary embodiments, some of the elements illustrated in FIG. 10 may be omitted or changed, or other elements may be added.

The storage 210 stores information received from the user terminal device 100 under the control of the processor 240. In addition, the storage 210 provides a content to be displayed.

The communicator 220 performs communication with the user terminal device 100.

Specifically, the communicator 220 may receive combined information which is set by a user from the user terminal device 100. For example, the received information may be a content to be displayed, a display schedule, etc. In addition, the communicator 220 may transmit information regarding a manufacturer, a model name of the digital signage device 200, location information of the device, etc. to the user terminal device 100.

Meanwhile, the communicator 220 may perform unilateral or bilateral communication with the user terminal device 100. When unilateral communication is performed, the communicator 220 may receive a signal from the user terminal device 100. When bilateral communication is performed, the communicator 220 may receive a signal from the user terminal device 100 and transmit a signal to the user terminal device 100.

The display 230 may display a content under the control of the processor 240. For example, the display 230 may display a content, a schedule, etc. which are received from the user terminal device 100 and stored in the storage 210.

The display 230 may be realized as Liquid Crystal Display Panel (LCD), Organic Light Emitting Diodes (OLED), etc., but is not limited thereto. In addition, the display 230 may be realized as a flexible display, a transparent display, etc. depending on exemplary embodiments.

When display information which is generated by combining information input through a UI screen of the user terminal device 100 and a content provided according to display information is received from the user terminal device 100, the processor 240 may store the received information in the storage 210 and display a content corresponding to the display information through the display 230 in real time based on the stored information.

In addition, a camera may be further included, and the processor 240 may acquire customer information including at least one of gender, race and age from an image photographed by the camera in real time and display a content corresponding to the acquired customer information.

The content may include tag information according to characteristics of each content, and the processor 240 may control the display 2300 to display a content including tag information corresponding to acquired customer information.

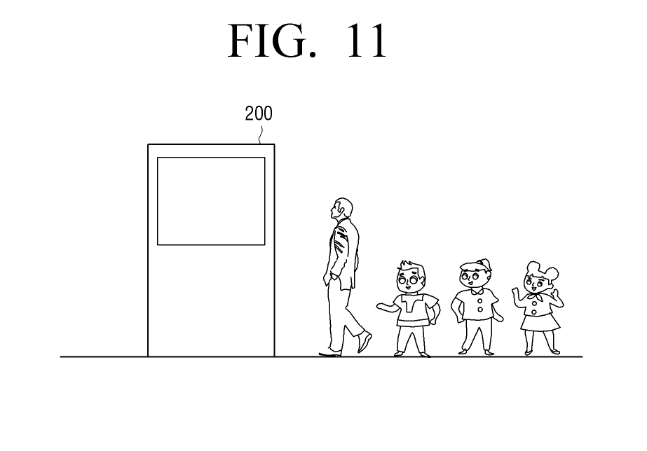

FIG. 11 is a view provided to explain an operation of acquiring customer information by the digital signage device 200 according to an exemplary embodiment.

Referring to FIG. 11, the digital signage device 200 may further include a camera. The processor 240 may acquire customer information including at least one of gender, race and age from an image photographed by the camera in real time. For example, referring to FIG. 11, the processor 240 may detect one adult and three children from a photographed image and acquire customer information regarding the ages.

The processor 240 may display a content corresponding to the acquired customer information. For example, by focusing on the three children, the processor 240 may display animation, toy advertisement, etc.

If a content includes tag information according to characteristics of each content, the processor 240 may display a content including tag information corresponding to acquired customer information. For example, if an advertisement for adult includes tag information corresponding to children, the processor 240 may display an advertisement for adult.

Meanwhile, the processor 240 may change the order of contents to be displayed and display the contents. For example, if there is no one around the digital signage device 200, the processor 240 may display each content in the order of 1->2-> . . . ->10. If one child is detected around the digital signage device 200, the processor 130 may display each content in the order of 1->5->9 which is the order of contents where children are tagged. If a child is no longer detected, the processor 130 may display each content again in the previous order of 1->2-> . . . ->10.

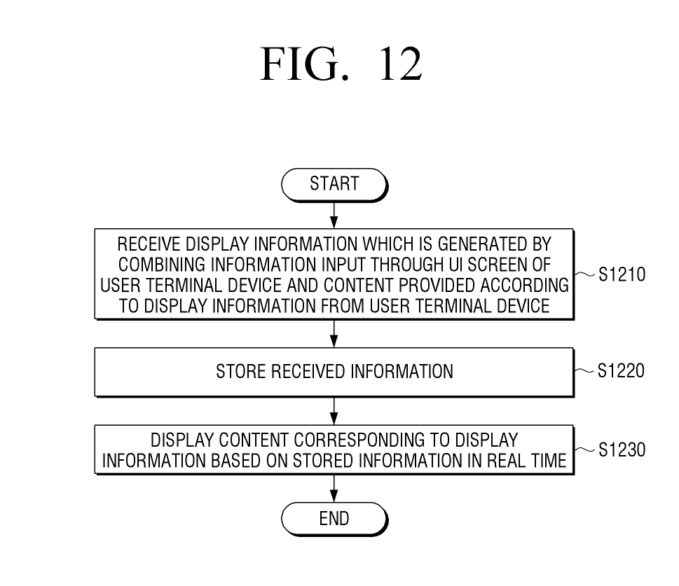

FIG. 12 is a flowchart provided to explain a method of controlling the digital signage device 200 according to an exemplary embodiment.

Referring to FIG. 12, a digital signage device 200 receives display information which is generated by combining information input through a UI screen of a user terminal device and a content provided according to the display information from the user terminal device (S1210). Subsequently, the digital signage device stores the received information (S1220), and display a content corresponding to the display information in real time based on the stored information (S1230).

In addition, the displaying step (S1230) includes acquiring customer information including at least one of gender, race and age from an image which is photographed in real time and displaying a content corresponding to the acquired customer information.

The content may include tag information corresponding to characteristics of each content, and the displaying step (S1230) may include displaying a content including tag information corresponding to the acquired customer information.

As described above, according to the various exemplary embodiments, a user terminal device and a digital signage device may display UI screens for editing a content and managing a display schedule, combine information input from each of the UI screens and display contents, thereby providing a user with a convenient method to display contents.

Meanwhile, the methods according to the various exemplary embodiments may be programmed and stored in various storage media. Accordingly, the methods according to the above-described various exemplary embodiments may be implemented in various types of electronic apparatuses which execute storage media.

Specifically, according to an exemplary embodiment, a non-transitory computer readable medium storing a program which sequentially performs the steps of displaying UI screens for editing a content to be provided on a digital signage device and managing a display schedule sequentially, combining information input from each of the UI screens displayed sequentially, and transmitting the generated information to the digital signage device may be provided.

The non-transitory recordable medium refers to a medium which may store data semi-permanently rather than storing data for a short time, such as register, cache, memory, etc. and is readable by an apparatus. Specifically, the above-described various applications and programs may be stored and provided in a non-transitory recordable medium such as CD, DVD, hard disk, Blu-ray disk, USB, memory card, ROM, etc.

While exemplary embodiments have been particularly shown and described above, it will be apparent to those skilled in the art that various changes may be made without departing from the scope of the inventive concept as defined by the following claims.

What is claimed is:

1. A user terminal device, comprising:
a display;
a communicator configured to perform communication with a digital signage device; and
a processor configured to control the display to display user interface (UI) screens for managing a content to be displayed on the digital signage device and schedules sequentially, configured to combine information input from each of the UI screens displayed sequentially and configured to transmit the combined information to the digital signage device.

2. The device as claimed in claim 1, wherein the processor is configured to control the display to sequentially display a first UI screen for receiving first information related to the content to be displayed on the digital signage device, to display a second UI screen for editing the content, and to display a third UI screen for managing display schedules of the content.

3. The device as claimed in claim 2, wherein the processor, in response to the first information being input on the first UI screen, is configured to control the display to provide candidate contents related to the input first information on the second UI screen, and
wherein in response to at least one content being selected from among the candidate contents provided on the second UI screen, the processor is configured to control the display to display the third UI screen including a basic display schedule management screen which is generated by applying a predetermined schedule template corresponding to the input first information to the selected at least one content.

4. The device as claimed in claim 2, wherein the processor, in response to receiving customer information from the digital signage device, is configured to control the display to provide the received customer information and candidate contents related to the input first information on the second UI screen.

5. The device as claimed in claim 1, wherein the processor is configured to control the display to display the UI screen comprising a first area for receiving a user command and a second area for providing a preview of the content to be displayed on the digital signage device, and
wherein the processor is configured to control the display to display a preview having information input from the first area being applied to a predetermined layout on the second area, configured to change the predetermined layout automatically based on the user command and configured to control the display to display a preview including the input information being applied to the changed layout.

6. The device as claimed in claim 1, wherein the processor, in response to a digital signage device being detected within a predetermined distance from the user terminal device, is configured to control the user terminal device to provide information regarding the detected digital signage device, and
wherein in response to a predetermined user command regarding the digital signage device being input, the processor is configured to control the display to display a UI screen for editing display schedule information received from the digital signage device.

7. The device as claimed in claim 1, wherein the processor is configured to control the display to provide the content based on display attributes of the digital signage device comprising model information of the digital signage device.

8. A digital signage device, comprising:
a storage;
a communicator configured to perform communication with a user terminal device;
a display configured to display a content; and
a processor configured to, in response to display information which is generated by combining information input through a UI screen of the user terminal device and a content which is provided according to the display information being received from the user terminal device, store the received display information in the storage and display the content on the display in real time based on the stored display information.

9. The device as claimed in claim 8, further comprising:
a camera configured to generate an image,
wherein the processor is configured to acquire customer information including at least one of gender, race and age from the image photographed by the camera in real time, and configured to control the display to display a content corresponding to the acquired customer information.

10. The device as claimed in claim 9, wherein the content comprises tag information based on characteristics of the content,
wherein the processor is configured to control the display to display a content including tag information corresponding to the acquired customer information.

11. A method of controlling a user terminal device, comprising:
displaying UI screens for managing a content to be displayed on a digital signage device and display schedules sequentially;
combining information input from each of the UI screens displayed sequentially; and
transmitting the combined information to the digital signage device.

12. The method as claimed in claim 11, wherein the displaying the UI screens comprises sequentially displaying a first UI screen for receiving first information related to the content to be displayed on the digital signage device, a second UI screen for editing the content, and a third UI screen for managing display schedules of the content.

13. The method as claimed in claim 12, wherein the displaying the UI screens comprises:
in response to the first information being input on the first UI screen, providing candidate contents related to the input first information on the second UI screen, and
in response to at least one content being selected from among the candidate contents provided on the second UI screen, displaying the third UI screen including a basic display schedule management screen generated by applying a predetermined schedule template corresponding to the input first information to the selected at least one content.

14. The method as claimed in claim 12, wherein the displaying the UI screens comprises, in response to receiving customer information from the digital signage device, providing the received customer information and candidate contents related to the input first information on the second UI screen.

15. The method as claimed in claim 11, wherein the UI screen comprises:
a first area for receiving a user command; and
a second area for providing preview of the content to be displayed on the digital signage device,
wherein the displaying the UI screens comprises, displaying a preview having information input from the first area being applied to a predetermined layout on the second area, changing the predetermined layout automatically based on the user command and displaying a preview including the input information being applied to the changed layout.

16. The method as claimed in claim 11, further comprising:
in response to a digital signage device being detected within a predetermined distance from the user terminal device, providing information regarding the detected digital signage device; and
in response to a predetermined user command regarding the digital signage device being input, displaying a UI screen for editing display schedule information received from the digital signage device.

17. The method as claimed in claim 11, wherein the displaying comprises providing the content based on display attributes of the digital signage device comprising model information of the digital signage device.

18. A method of controlling a digital signage device, comprising:
receiving display information generated by combining information input through a UI screen of the user terminal device;
receiving a content which is provided according to the display information from the user terminal device;
storing the received display information; and
displaying the content on the display in real time based on the stored display information.

19. A user terminal device comprising:
a communicator configured to perform communication with a digital signage device; and
a processor configured to control a display to display user interface (UI) screens for managing a content to be displayed on the digital signage device and schedules sequentially, configured to combine information input from each of the UI screens displayed sequentially and configured to transmit the combined information to the digital signage device.

20. A digital signage device, comprising:
a storage;
a communicator configured to perform communication with a user terminal device;
a processor configured to, in response to display information which is generated by combining information input through a UI screen of the user terminal device and a content which is provided according to the display information being received from the user terminal device, store the received display information in the storage and display the content on a display device in real time based on the stored display information.
